(19) United States
(12) Patent Application Publication
(10) Pub. No.: US 2013/0337293 A1
(43) Pub. Date: Dec. 19, 2013

(54) LITHIUM-SULFUR CELL BASED ON A SOLID ELECTROLYTE

(71) Applicants: Ulrich Eisele, Stuttgart (DE); Andre Moc, Grossshchoenau (DE); Alan Logeat, Stuttgart (DE)

(72) Inventors: Ulrich Eisele, Stuttgart (DE); Andre Moc, Grossshchoenau (DE); Alan Logeat, Stuttgart (DE)

(21) Appl. No.: 13/977,286

(22) PCT Filed: Nov. 7, 2011
(86) PCT No.: PCT/EP2011/069502

§ 371 Date: Sep. 6, 2013

(30) Foreign Application Priority Data
Dec. 29, 2010 (DE) 102010064302.5

(51) Int. Cl. H01M 6/18; H01M 10/0562

(52) U.S. Cl. CPC H01M 6/186; H01M 10/0562
USPC 429/50; 429/231.95; 429/322

(57) ABSTRACT

A lithium-sulfur cell which may be operated at room temperature or at a higher temperature, the anode and the cathode of the lithium-sulfur cell being separated by a lithium ion-conducting and electron-nonconducting solid electrolyte. Also described is an operating method for such a lithium sulfur cell and to the use of such a lithium-sulfur cell.

### FIELD OF THE INVENTION

The present invention relates to a lithium-sulfur cell, an operating method for a lithium-sulfur cell and the use of a lithium-sulfur cell.

### BACKGROUND INFORMATION

Batteries are important today for both mobile and stationary applications. Lithium-sulfur cells are of particular interest since they are capable of achieving a high theoretical specific energy density of 2500 Wh/kg in a small size.

### SUMMARY

The subject matter of the present invention is a lithium-sulfur cell having an anode (negative electrode) and a cathode (positive electrode), the anode containing lithium and the cathode containing sulfur. The anode and cathode are separated by at least one lithium ion-conducting and electron-nonconducting solid electrolyte.

In the sense of the present invention, a lithium ion-conducting material may be understood in particular to be a material having a lithium ion conductivity of ≧1·10⁻⁶ S/cm at 25° C. In the sense of the present invention, an electron-nonconducting material may be understood to be a material having an electron conductivity of <1·10⁻⁸ S/cm at 25° C.

Separation of the anode and cathode by a lithium ion-conducting and electron-nonconducting electrolyte has the advantage that it is possible in this way to prevent short circuits at low temperatures, such as <115° C., for example, and at high temperatures, such as ≧115° C., for example. Furthermore, the lithium ion-conducting and electron-nonconducting solid electrolyte separator makes it possible to provide a solid lithium-sulfur cell, which includes only solid electrolytes in particular and may therefore be operated without liquid electrolytes, which may also be flammable.

Within the scope of one specific embodiment, the lithium ion-conducting and electron-nonconducting solid electrolyte has a garnet structure. Sulfur advantageously has little or no solubility in lithium ion-conducting and electron-nonconducting solid electrolytes having a garnet structure. Furthermore, lithium ion-conducting and electron-nonconducting solid electrolytes having a garnet structure are nonflammable and nontoxic. Lithium ion-conducting and electron-nonconducting solid electrolytes having a garnet structure have proven advantageous for operation at high temperatures in particular.

Within the scope of another specific embodiment, the lithium ion-conducting and electron-nonconducting solid electrolyte has a garnet structure of the general formula:

LiₓA₃B₂O₁₂

where 3≦x≦7, and A stands for potassium, magnesium, calcium, strontium, barium, yttrium, lanthanum, praseodymium, neodymium, samarium, europium, gadolinium, terbium, dysprosium, holmium, erbium, thulium, ytterbium and/or lutetium, and B stands for zirconium, hafnium, niobium, tantalum, tungsten, indium, tin, antimony, bismuth and/or tellurium.

For example, the lithium ion-conducting and electron-nonconducting solid electrolyte may have a garnet structure of the formula Li₇La₃Zr₂O₁₂.

Within the scope of another specific embodiment, the anode is made of metallic lithium or a lithium alloy, in particular metallic lithium. A high maximum voltage may thus be achieved advantageously. The lithium anodes may be either solid or liquid, depending on the operating temperature, since lithium has a melting point of 189° C. and the lithium-sulfur cell is operable at low temperatures as well as at high temperatures, in particular above 189° C.

The cathode for increasing the electron conductivity may include one or multiple materials, selected from the group including graphite, carbon nanotubes, carbon black and lithium ions and electron-conducting solid electrolyte structures, for example.

Within the scope of another specific embodiment, the lithium-sulfur cell has at least one lithium ion-conducting and electron-conducting solid electrolyte on the cathode side in particular. The reaction zone between electrolyte, sulfur and electrically conductive structures, which would otherwise be three phases, may thus be reduced to a two-phase reaction zone, namely between the lithium ion-conducting and electron-conducting solid electrolyte on the one hand and sulfur on the other hand, and therefore the reaction kinetics may be increased advantageously due to a lithium ion-conducting and electron-conducting solid electrolyte, in particular on the cathode side.

Within the scope of another specific embodiment, the side of the lithium ion-conducting and electron-nonconducting solid electrolyte which faces the cathode is covered with a layer of a lithium ion-conducting and electron-conducting solid electrolyte. Thus the three-phase reaction zone between electrolyte, sulfur and electrically conducting structures in particular may advantageously be reduced to a two-phase reaction zone, namely between the lithium ion-conducting and electron-conducting solid electrolyte on the one hand and sulfur on the other hand and thus the reaction kinetics may be increased.

Alternatively or additionally, the cathode may include at least one lithium ion-conducting and electron-conducting solid electrolyte. The lithium and electron-conducting solid electrolyte is preferably infiltrated with sulfur. This has the advantage that the cathode may be lithium ion-conducting even at low temperatures, at which sulfur is present as a solid, in particular at less than 115° C. In addition, this advantageously makes it possible to omit liquid electrolytes, which might also be flammable. Thus a solid lithium-sulfur cell may advantageously be made available.

Within the scope of another specific embodiment, the lithium-sulfur cell is therefore a lithium-sulfur cell based on a solid electrolyte, i.e., based on a solid. In particular the lithium-sulfur cell may not contain any electrolytes which are liquid at room temperature (25° C.) and include, for example, exclusively solid electrolytes—except for molten sulfur and/or polysulfides, as the case may be. Such lithium-sulfur cells may be operated advantageously at temperatures of ≧115° C., for example, ≧200° C., or ≧300° C., if necessary, as well as at temperatures of <115° C. With such lithium-sulfur cells it is advantageously possible to omit the addition of liquid and possibly flammable electrolytes. The safety and cycle stability may thus be advantageously improved. Furthermore, a lithium ion-conducting and electron-conducting solid electrolyte may also function as a current conductor at the same time, so that no additional additives are needed to increase the electrical conductivity and the total energy density of the cell may be optimized.

Within the scope of another specific embodiment, the cathode includes at least one conductive element of a lithium ion-conducting and electron-conducting solid electrolyte. Lithium ions and electrons may both advantageously be transported via such a conductive element to the sulfur reactant. The conductive element may be designed in the form of a porous body, for example, a sponge body, and/or in the form of a wire mesh or fiber mesh, for example, of nanowires or nanofibers and/or in the form of nanotubes. Nanowires, nanofibers and nanotubes may be understood in particular to be wires or fibers or tubes having an average diameter of ≦500 nm, for example, ≦100 nm. However, it is also possible for the cathode to include a plurality of, e.g., rod-,plate- or lattice-shaped, conductive elements.

Within the scope of another specific embodiment, one section of the conductive element(s) contacts the lithium ion-conducting and electron-nonconducting solid electrolyte, while another section of the conductive element(s) contacts a cathode current collector. In this way, a good lithium ion and electron conduction may be ensured. For example, a section of a conductive element designed in the form of a porous body or a wire or fiber mesh may contact the lithium ion-conducting and electron-nonconducting solid electrolyte and another section of the conductive element designed in the form of a porous body or a wire or fiber mesh may contact the cathode current collector.

The cathode may in particular include a plurality of conductive elements of a lithium ion-conducting and electron-conducting solid electrolyte, one section of which contacts the lithium ion-conducting and electron-nonconducting solid electrolyte and another section contacts the cathode current collector. In this way, good lithium ion and electron conduction may be ensured in particular. For example, the cathode may include a plurality of planar or curved plate-shaped or lattice-shaped conductive elements situated at a distance from one another, each contacting on the one hand the lithium ion-conducting and electron-nonconducting solid electrolyte and, on the other hand, the cathode current collector. The conductive elements may be situated essentially in parallel to one another here. For example, the conductive elements may be situated like the slats of a blind with respect to one another. The conductive elements may be positioned essentially at a right angle with respect to the lithium ion-conducting and electron-nonconducting solid electrolyte and the cathode current collector.

Within the scope of another specific embodiment, structures of a lithium ion-conducting and electron-conducting solid electrolyte are formed on the conductive element(s). The surface of the conductive element and thus the area available for the lithium-sulfur redox reaction may advantageously be increased by these structures. These structures may be, for example, structures in the range of a few microns or nanometers.

The conductive elements and structures may be formed from the same or different lithium ion-conducting and electron-conducting solid electrolytes. The conductive elements and structures may be formed from the same lithium and electron-conducting solid electrolytes in particular.

Within the scope of another specific embodiment, the structures are formed by lithium ion-conducting and electron-conducting solid electrolyte crystals, e.g., in needle form. Such structures are or may be formed by hydrothermal synthesis on the conductive element, for example.

Within the scope of another specific embodiment, the lithium ion-conducting and electron-conducting solid electrolyte is or contains at least one lithium titanate. Within the scope of the present invention, a lithium titanate may be a pure lithium titanate or a lithium titanate mixed oxide or a doped lithium titanate, which includes one or multiple foreign atoms (metal cations other than lithium and titanium), in particular oxides of foreign atoms, in particular where the number of foreign atoms amounts to a total of >0% to ≦10%, for example, >0% to ≦1%, based on the number of titanium atoms.

With a lithium titanate mixed oxide or a doped lithium titanate, the lithium ion and electron conductivity may advantageously be adjusted by the type and quantity of foreign atoms.

The lithium titanate may be or include in particular a lithium titanate mixed oxide, for example, Li₄₋ₓMgₓTi₅O₁₂, where 0≦x≦2 or 0≦x≦1 and/or Li₄₋ₓMgₓTi_{5-y}(Nb, Ta)_{y}O₁₂, where 0≦x≦2 or 0≦x≦1 and 0≦y≦0.1 or 0≦y≦0.05 and/or Li₂₋ₓMgₓTi_{3-y}(Nb, Ta)_{y}O₇, where 0≦x≦1 or 0≦x≦0.5 and 0≦y≦0.03.

Within the scope of another specific embodiment the cathode has at least one electron-conducting (and lithium ion-nonconducting) solid which is selected in particular from the group including graphite, carbon black, carbon nanotubes and combinations thereof.

With regard to further features and advantages of the lithium-sulfur cell according to the present invention, reference is herewith made explicitly to the explanations in conjunction with the method according to the present invention, the use according to the present invention and the description of the figures.

Another subject matter of the present invention is a method for operating a lithium-sulfur cell, which includes an anode and a cathode, the anode containing lithium and the cathode containing sulfur, and the anode and cathode being separated by at least one lithium ion-conducting and electron-nonconducting solid electrolyte, the lithium-sulfur cell being operated at a temperature of ≧115° C. This method is suitable in particular for operation of a lithium-sulfur cell according to the present invention.

Sulfur melts at a temperature of 115° C. and thus becomes liquid, so that better electrical contacting of the electrically conductive structures, for example, graphite, etc. and/or the cathode current collector and also an improved charge transport through a convection of polysulfides dissolved in the sulfur may advantageously be achieved. It is therefore advantageously possible to omit the addition of lithium ion-conducting materials to the cathode material. For example, in addition to sulfur, the cathode may contain only additives such as graphite to improve the electrical conductivity, so that the cost of the materials may be advantageously reduced. Furthermore, the lithium ion conductivity of the solid electrolytes may be increased by increasing the operating temperature to more than 115° C.

The lithium anode is advantageously still solid in a temperature range of 115° C. to 189° C., which is why a greater safety may be achieved by using a lithium-sulfur cell operated in this way in comparison with a similar sodium-sulfur cell (melting point of sodium=98° C.).

Within the scope of another specific embodiment, the lithium-sulfur cell is therefore operated in a temperature range of ≧115° C. to ≦189° C.

However, within the scope of yet another further specific embodiment, the lithium-sulfur cell is operated at a temperature of ≧200° C., or ≧300° C. if necessary. The lithium ion conductivity of the lithium ion-conducting solid electrolyte as well as that of the sulfur may advantageously be further increased.

With regard to further features and advantages of the method according to the present invention, reference is herewith made explicitly to the explanations in conjunction with the lithium-sulfur cell according to the present invention, the use of same and the description of the figures.

Furthermore, the present invention relates to the use of a lithium-sulfur cell according to the present invention at a temperature of ≧115° C., in particular ≧200° C., for example, ≧300° C.

With regard to further features and advantages of the method according to the present invention, reference is herewith made explicitly to the explanations in conjunction with the lithium-sulfur cell according to the present invention, the method according to the present invention and the description of the figures.

### BRIEF DESCRIPTION OF THE DRAWINGS

FIG. 1 shows a schematic cross section through a first specific embodiment of a lithium-sulfur cell according to the present invention.

FIG. 2a shows a schematic cross section through a second specific embodiment of a lithium-sulfur cell according to the present invention, and

FIG. 2b shows an enlargement of the marked area in FIG. 2a.

### DETAILED DESCRIPTION

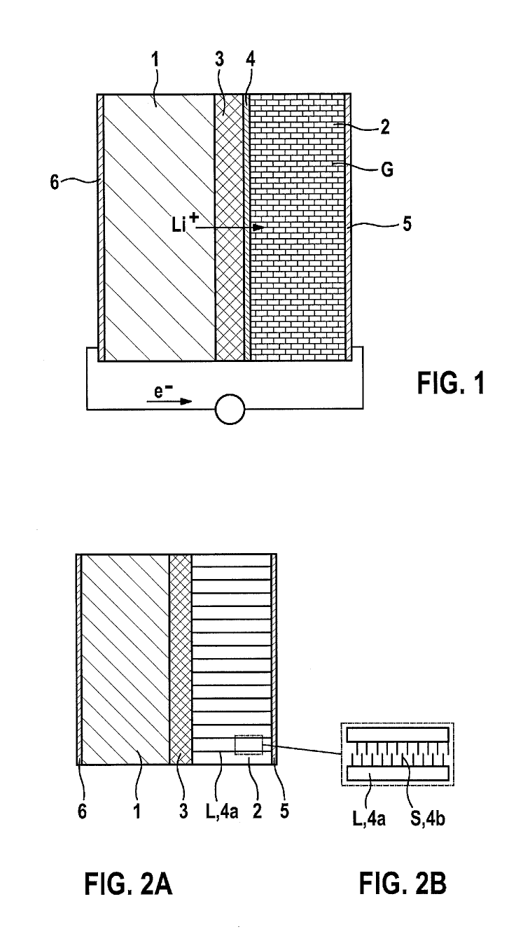

FIG. 1 shows a first specific embodiment of a lithium-sulfur cell according to the present invention, which includes an anode 1 and a cathode 2, anode 1 and cathode 2 being separated by at least one lithium ion-conducting and electron-nonconducting solid electrolyte 3, for example, having a garnet structure. Anode 1 may be made of metallic lithium, for example. FIG. 1 shows that cathode 2 includes an electron-conducting solid G, for example, graphite, in addition to sulfur. Such a lithium-sulfur cell is suitable for operation at temperatures of ≧115° C. in particular. The lithium-sulfur cell shown in FIG. 1 may therefore also be referred to as a high-temperature lithium-sulfur cell.

FIG. 1 also shows that the lithium-sulfur cell has a lithium ion-conducting and electron-conducting solid electrolyte 4 on the cathode side, for example, a lithium titanate. The side of the lithium ion-conducting and electron-nonconducting solid electrolyte 3 facing cathode 2 is covered in particular with a layer 4 of the lithium ion-conducting and electron-conducting solid electrolyte 4.

Furthermore, FIG. 1 shows that anode 1 has an anode current collector 6, and cathode 2 has a cathode current collector 5.

The second specific embodiment shown in FIGS. 2a and 2b differs essentially from the first specific embodiment shown in FIG. 1 in that the lithium-sulfur cell does not have a lithium ion-conducting and electron-conducting layer 4 covering separator 3, and instead of electron-conducting solid G, cathode 2 has a plurality of conductive elements L of a lithium ion-conducting and electron-conducting solid electrolyte 4a, for example, a lithium titanate, one section of which contacts the lithium ion-conducting and electron-nonconducting solid electrolyte 3 and another section contacts cathode current collector 5.

FIG. 2b shows that structures S of a lithium ion-conducting and electron-conducting solid electrolyte 4b are formed on conductive elements L. These may be, for example, needle-shaped lithium ion-conducting and electron-conducting solid electrolyte crystals, for example, lithium titanate crystals. These may be formed by hydrothermal synthesis on conductive elements L, for example.

Such a lithium-sulfur cell is suitable for operation at temperatures of ≧115° C. as well as for operation at temperatures of <115° C. The lithium-sulfur cell shown in FIGS. 2a and 2b may therefore be referred to as a high-temperature lithium-sulfur cell as well as a low-temperature lithium-sulfur cell.

1-15. (canceled)

16. A lithium-sulfur cell, comprising:
an anode;
a cathode, wherein:
the anode includes lithium, and
the cathode includes sulfur; and
at least one lithium ion-conducting and electron-nonconducting solid electrolyte separating the anode and the cathode.

17. The lithium-sulfur cell as recited in claim 16, wherein the lithium ion-conducting and electron-nonconducting solid electrolyte has a garnet structure.

18. The lithium-sulfur cell as recited in claim 16, wherein the lithium ion-conducting and electron-nonconducting solid electrolyte has a garnet structure of the general formula
LiₓA₃B₂O₁₂
where 3≦x≦7; A stands for at least one of potassium, magnesium, calcium, strontium, barium, yttrium, lanthanum, praseodymium, neodymium, samarium, europium, gadolinium, terbium, dysprosium, holmium, erbium, thulium, ytterbium and lutetium; and B stands for at least one of zirconium, hafnium, niobium, tantalum, tungsten, indium, tin, antimony, bismuth, and tellurium.

19. The lithium-sulfur cell as recited in claim 16, wherein the anode is formed from one of a metallic lithium and a lithium alloy.

20. The lithium-sulfur cell as recited in claim 16, further comprising:
at least one lithium ion-conducting and electron-conducting solid electrolyte.

21. The lithium-sulfur cell as recited in claim 20, wherein the lithium ion-conducting and electron-conducting solid electrolyte is provided on a cathode side.

22. The lithium-sulfur cell as recited in claim 20, wherein the side of the lithium ion-conducting and electron-nonconducting solid electrolyte facing the cathode is covered with a layer of the lithium ion-conducting and electron-conducting solid electrolyte.

23. The lithium-sulfur cell as recited in claim 20, wherein the cathode includes at least one conductive element of the lithium ion-conducting and electron-conducting solid electrolyte.

24. The lithium-sulfur cell as recited in claim 23, wherein structures of the lithium ion-conducting and electron-conducting solid electrolyte are formed on the conductive element.

25. The lithium-sulfur cell as recited in claim 24, wherein the structures include needle-shaped lithium ion-conducting and electron-conducting solid electrolyte crystals.

26. The lithium-sulfur cell as recited in claim 23, wherein:
a section of the conductive element contacts the lithium ion-conducting and electron-nonconducting solid electrolyte, and
another section of the conductive element contacts a cathode current collector.

27. The lithium-sulfur cell as recited in claim 20, wherein the lithium ion-conducting and electron-conducting solid electrolyte includes a lithium titanate.

28. The lithium-sulfur cell as recited in claim 16, wherein the lithium-sulfur cell is a lithium-sulfur cell based on a solid electrolyte that is liquid at room temperature.

29. The lithium-sulfur cell as recited in claim 16, wherein the cathode contains at least one electron-conducting solid corresponding to one of graphite, carbon black, carbon nanotubes, and combinations thereof.

30. A method for operating a lithium-sulfur cell that includes an anode including lithium, a cathode including sulfur, and at least one lithium ion-conducting and electron-nonconducting solid electrolyte separating the anode and the cathode, the method comprising:
operating the lithium-sulfur cell at a temperature of ≧115° C.

31. The method as recited in claim 30, wherein the lithium cell is operated in a temperature range of ≧115° C. to ≦189° C.

32. The method as recited in claim 30, wherein the lithium cell is operated at a temperature of ≧200° C.

33. The method as recited in claim 30, wherein the lithium cell is operated at a temperature of ≧300° C.
